(19) United States
(12) Patent Application Publication
(10) Pub. No.: US 2010/0010917 A1
(43) Pub. Date: Jan. 14, 2010

(54) AUTO-ADJUSTING ORDER CONFIGURATION RULES USING PARTS SUPPLY

(75) Inventors: Derek P. Bagwell, Rochester, MN (US); Joni L. Buttke, Norwalk, CT (US); Ivory W. Knipfer, Rochester, MN (US); Cheranellore Vasudevan, Bastrop, TX (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/169,611

(22) Filed: Jul. 8, 2008

(51) Int. Cl. G06Q 10/00

(52) U.S. Cl. 705/27

(57) ABSTRACT

Embodiments of the present invention address deficiencies of the art in respect to commercial order processing and provide a novel and non-obvious method, computer system and computer program product for facilitating selection of configurations using supply data. In one embodiment of the invention, a method for facilitating configuration selection when ordering computer equipment is provided. The method includes reading a plurality of configuration rules that define constituent parts that are presented to a user for selection when ordering the end product. The method further includes reading supply data for the constituent parts, interpreting the supply data based on a set of user-definable meta rules, and modifying the plurality of configuration rules in accordance with the interpretations of the supply data. The method further includes receiving a request from the user to order the end product and providing the user with information regarding constituent parts that comprise the end product, according to the plurality of configuration rules.

### BACKGROUND OF THE INVENTION

1. Field of the Invention

The present invention relates to commercial ordering processes, and more particularly to improved methods for processing commercial orders for a computer product using constituent part supply data.

2. Description of the Related Art

Complex commercial computer systems are available in a wide variety of configurations. When ordering complex commercial computer systems, customers are typically provided with a choice of various configurations, including a choice of brand, software, peripheral components and other customizations so as to provide the customer with a product that satisfies his needs as precisely as possible. When initiating such orders online, customers are usually presented with an order configurator or sales configurator, which is a computer program that specifies and validates compatibility between selected parts, the existence of pre-requisite and co-requisite parts and the capacity of desired product to hold all selected parts, thereby generating a valid order for a computer product.

Order configurators typically comprise a grouping of hard-coded rules that enforce the selection of pre-requisite parts, co-requisite parts, compatibility of parts and capacity. These rules are usually prescribed by product engineers and marketing. The rules are often updated periodically to reflect upcoming products, production needs and corrections. Because order configurators do not take supply data of constituent parts into account, however, order configurators may generate orders containing parts that are out of stock or in short supply or have other actual or planned disruptions in supply, changing quality yields, resource availability, equipment down time, and so on are all factors that may impact supply. If the customer configures parts that are out of stock or low in supply, there is a possibility that order execution will be delayed, production schedules are lengthened, or delivery is delayed, all of which negatively impact customer satisfaction.

Therefore, there is a need for a more efficient way of facilitating configuration selection for a computer product by taking into account supply data of the constituent parts of the computer product.

### BRIEF SUMMARY OF THE INVENTION

Embodiments of the present invention address deficiencies of the art in respect to commercial order processing and provide a novel and non-obvious method, computer system and computer program product for facilitating selection of configurations using supply data. In one embodiment of the invention, a method for facilitating configuration selection when ordering computer equipment is provided. The method includes reading a plurality of configuration rules that define constituent parts that are presented to a user for selection when ordering the end product. The method further includes reading supply data for the constituent parts and modifying the plurality of configuration rules in accordance with the supply data. The method further includes user-definable ways of interpreting the supply data through a set of meta rules. The method further includes receiving a request from the user to order the end product and providing the user with information regarding constituent parts that comprise the end product, according to the plurality of configuration rules.

In another embodiment of the invention, a computer program product comprising a computer usable medium embodying computer usable program code for facilitating configuration selection when ordering computer equipment can be provided. The computer program product can include computer usable program code for reading a plurality of configuration rules that define constituent parts that are presented to a user for selection when ordering the end product. The computer program product can further include computer usable program code for reading supply data for the constituent parts and modifying the plurality of configuration rules in accordance with the supply data. The computer program product can further include computer usable program code for receiving a request from the user to order the end product and providing the user with information regarding constituent parts that comprise the end product, according to the plurality of configuration rules.

In another embodiment of the invention, a computer system for facilitating configuration selection when ordering computer equipment is provided. The computer system includes a data repository for storing a plurality of configuration rules that define constituent parts that are presented to a user for selection when ordering the end product and for storing supply data for the constituent parts. The computer system further includes a processor configured for reading the plurality of configuration rules and the supply data and modifying the plurality of configuration rules in accordance with the supply data. The computer system further includes an interface for receiving a request from the user to order the end product and providing the user with information regarding constituent parts that comprise the end product, according to the plurality of configuration rules.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a network architecture for a system for facilitating configuration selection when a user orders computer equipment, according to one embodiment of the present invention;

FIG. 2 is a block diagram depicting a process for adjusting configuration rules so as to reflect current supply data, according to one embodiment of the present invention;

FIG. 3 is a flow chart depicting a process for executing a sample supply data interpretation rule, according to one embodiment of the present invention; and

FIG. 4 is a chart illustrating an if-then rule comprising a supply data interpretation rule 116, in accordance with one embodiment of the present invention.

### DETAILED DESCRIPTION OF THE INVENTION

Embodiments of the present invention address deficiencies of the art in respect to commercial order processing and provide a novel and non-obvious method, computer system and computer program product for facilitating selection of configurations using supply data. In one embodiment of the invention, a method for facilitating configuration selection when ordering computer equipment is provided. The method includes reading a plurality of configuration rules that define constituent parts that are presented to a user for selection when ordering the end product. The method further includes reading supply data for the constituent parts, interpreting the supply data based on a set of meta rules, and modifying the plurality of configuration rules in accordance with the supply data. The method further includes receiving a request from the user to order the end product and providing the user with information regarding constituent parts that comprise the end product, according to the plurality of configuration rules.

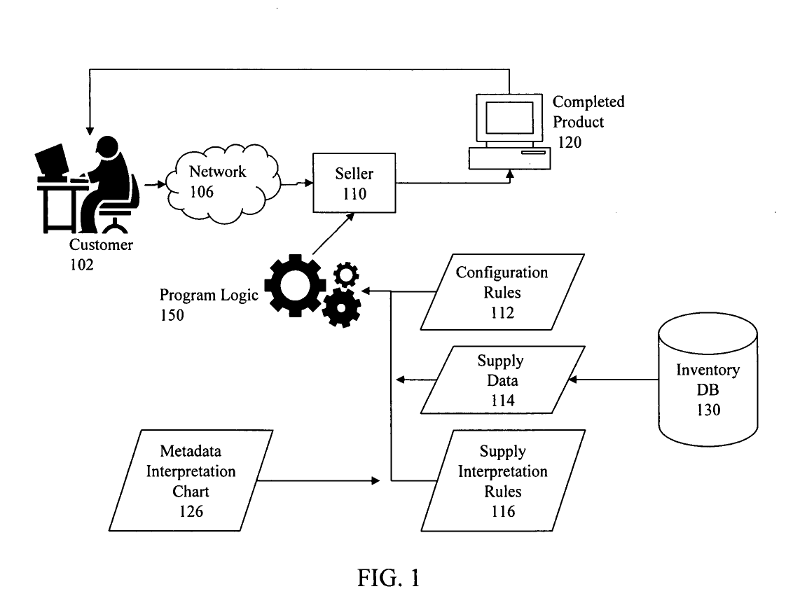

FIG. 1 is a block diagram illustrating a network architecture for a system for facilitating configuration selection when a user orders computer equipment, according to one embodiment of the present invention. FIG. 1 shows a customer interacting with a computer 102 to access a network 106, such as the World Wide Web. The computer 102 may be a personal computer, a server, a workstation, a smart phone, or a personal digital assistant. Also connected to the network 106 is the seller 110 of complex computer systems via a web server, which may be any commercially available web server, such as the IBM HTTP Server available from International Business Machines, Corp. of Armonk, N.Y.

According to FIG. 1, customer executes a client application, such as a web browser, on computer 102 to access the seller 110 of computer systems via the network 106. The seller 100, via an interface, presents information to the customer regarding constituent parts for a computer product that is desired by the customer. The information presented to the user regarding constituent parts is based on the execution of the configuration rules 112, wherein configuration rules include data pertaining to pre-requisite parts (parts that are required before another part is included in a computer product), co-requisite parts (parts that are required in conjunction with another part is included in a computer product), compatibility of selected parts, capacity of a selected configuration to accept certain selected parts, etc.

The information presented to the user regarding constituent parts is also based on supply data 114, at least partially originating from inventory/supply data database 130, wherein supply data includes at least how many units of a particular part are currently in the inventory of parts available to the manufacturing process. Supply data also includes data pertaining to availability data for each constituent part, in-stock data for each constituent part, lead time data for each constituent part, quality data for each constituent part, etc. Lastly, the configuration rules 112 are modified by the supply data interpretation rules 116 based on the supply data 114, and the metadata interpretation chart 126, as explained in greater detail below.

In one embodiment of the present invention, the web server of seller 110 includes a program logic 150 comprising computer instructions for reading supply data 114, modifying the configuration rules 112 according to supply data interpretation rules 116 and metadata interpretation chart 126, and further executing configuration rules 112, thereby determining which information is presented to the customer regarding constituent parts for a computer product that is desired by the customer, as described in greater detail below. Program logic 150, or any portion thereof, may comprise a scripting language code or interpreted language code such as Perl, PHP, server-side VBScript, JavaScript, or client-side VBScript. Program logic 150, or any portion thereof, may be embedded in HTML code served by the web server of seller 110.

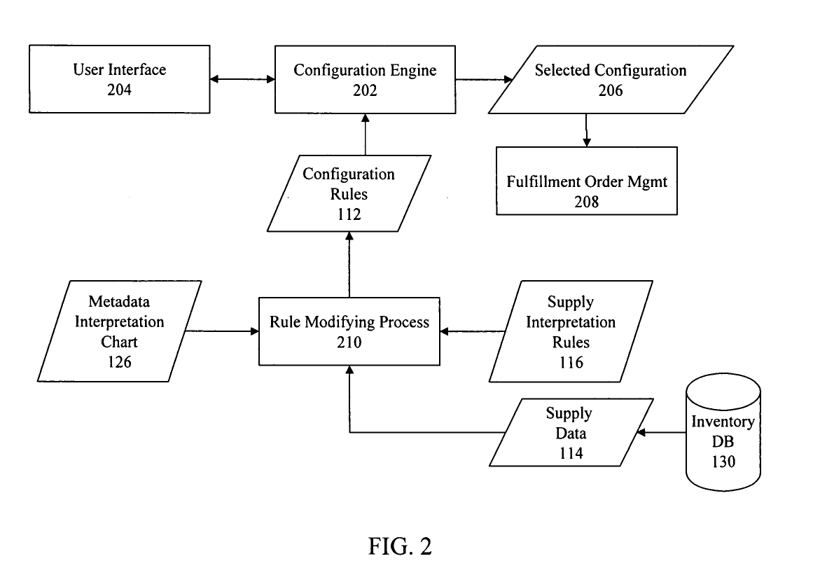

The process by which program logic 150 reads supply data 114, modifies the configuration rules 112 according to supply data interpretation rules 116 and metadata interpretation chart 126, and further executes configuration rules 112, thereby determining which information is presented to the customer regarding constituent parts for a computer product that is desired by the customer, is provided in greater detail below with reference to FIG. 2. Subsequent to the processing of the customer's order, the seller 110 produces a completed product 120 corresponding to the customer's order and the product 120 is shipped to the customer.

FIG. 2 is a block diagram depicting a process for adjusting configuration rules 112 so as to reflect current supply data 114, according to one embodiment of the present invention. FIG. 2 describes in more detail the process by which program logic 150 reads supply data 114, modifies the configuration rules 112 according to supply data interpretation rules 116 and metadata interpretation chart 126, and further executes configuration rules 112, thereby determining which information is presented to the customer regarding constituent parts for a computer product that is desired by the customer.

FIG. 2 shows a configuration engine 202 that encompasses the process of executing the configuration rules 112 that enforce the selection of pre-requisite parts, co-requisite parts, compatibility of selected parts, etc. when a desired computer product is being ordered by a customer 102. A user interface 204, such as a web interface or the like, is presented to the customer 102 so as to exchange information during the ordering and product configuration process.

FIG. 2 also includes a rules modifying process 210 that modifies the configuration rules 112 according to supply data interpretation rules 116, supply data 114, metadata interpretation chart 126, as explained in greater detail below.

Metadata interpretation chart 126 is used to determine designations for supply data 114. As explained above, various types of data, such as in-stock levels of a part, can be included in supply data 114. Metadata interpretation chart 126 is used, for example, to determine whether the in-stock level of a part is considered, low, adequate or abundant. The metadata interpretation chart 126 may include, for example, a chart that defines for each part the in-stock values that correspond to a “low” level, the in-stock values that correspond to an “adequate” level, and the in-stock values that correspond to an “abundant” level. As further examples, metadata interpretation chart 126 can be used to determine the usage rate of a part or whether a re-stock time for a part is considered short, medium or large. This process is executed prior to all other processes by rules modifying process 210.

The rules modifying process 210 subsequently reads supply data 114, inserts values from supply data 114 into the if-portion of supply data interpretation rules 116, executes the supply data interpretation rules 116 and then modifies supply data the configuration rules 112 based on the actions stated in the then-portion of interpretation rules that have been triggered during execution.

As explained above, configuration rules 112 include rules that enforce the selection of pre-requisite parts, co-requisite parts, compatibility of selected parts, capacity of a selected configuration to accept certain selected parts, etc. when a desired computer product is being ordered by a customer 102 using configuration engine 202. In one example, a configuration rule may include one or more part identifiers in the if-portion of the rule and an action in the then-portion of the rule. In this example, the action includes displaying one or more identified parts. If the parts identified in the if-portion of the rule are selected by a customer 102 during the ordering process, then the rule would be triggered and the parts identified in the then-portion of the rule would be displayed to the customer 102 during the ordering process. Such a rule would identify parts that are co-requisites of the parts identified in the if-portion of the rule.

In another example, a configuration rule may include one or more part identifiers in the if-portion of the rule and an action in the then-portion of the rule, comprising NOT displaying one or more identified parts. If the parts identified in the if-portion of the rule are selected by a customer 102 during the ordering process, then the rule would be triggered and the parts identified in the then-portion of the rule would NOT be displayed to the customer 102 during the ordering process. Such a rule would identify parts that are not compatible with the parts identified in the if-portion of the rule.

The action in the then-portion of a configuration rule can include setting a priority level for a part, wherein a priority level indicates the manner in which a part is presented to a customer 102 when placing an order for a computer product that includes the part. A customer 102 placing an order may be encouraged to select parts with high priority, since stock levels for those parts may be high. A customer 102 placing an order may be discouraged to select parts with low priority, since stock levels for those parts may be low. A customer 102 placing an order may not even be presented with parts with very low priority, since those parts may be out of stock completely.

Supply data interpretation rules 116 are used by rules modifying process 210 to modify the configuration rules 112 based on the supply data 114. The rules modifying process 210 reads supply data 114, inserts values from supply data 114 into the if-portion of supply data interpretation rules 116, executes the supply data interpretation rules 116 and then modifies the configuration rules 112 based on the actions stated in the then-portion of supply data interpretation rules that have been triggered during execution. Note that certain values, such as designators for in-stock values for a part, may be garnered from metadata interpretation chart 126, as explained in greater detail above.

In one example, an supply data interpretation rule includes a part identifier and a stock level for the identified part in the if-portion of the rule. The stock level for the identified part can be garnered from the supply data 114. The supply data interpretation rule also includes an action in the then-portion of the rule, such as lowering priority of the identified part so as to discourage selection of the identified part. If the stock levels of the identified part are low, such a rule would be triggered, resulting in a modification of the configuration rule 112 so as to limit the manner in which the identified part is presented to an ordering customer 102, thereby reducing the amounts of the identified part being ordered.

Various data pertaining to a part can be stated in the if-portion of an supply data interpretation rule. This includes the part number of the part, whether there is an equivalent part, the part number of an equivalent part (if any) and a selection type of the part during the configuration process (user selected, automatically expanded, etc.). Additionally, various supply data pertaining to a part can be stated in the if-portion of an supply data interpretation rule. This includes the current stock level of the part, the number of days it takes to restock the part (lead time) and a date range specifying the duration of the current stock level of the part.

The then-portion of an supply data interpretation rule may include an action text explaining the goal of the action in the then-portion of the rule. Examples of an action text include “discourage selection of the identified part,” “avoid the identified part in the configuration,” “replace the identified part with an equivalent part” and “do not expand this part.” The then-portion of an supply data interpretation rule may also include an action. Examples of an action include “reduce priority of the identified part,” “increase priority of the identified part,” “eliminate the identified part from presentation to the customer and replace with equivalent part,” “generate a warning message about potential delays in delivery,” “do not auto expand part” and “replace co-requisite part or pre-requisite part with another part.”

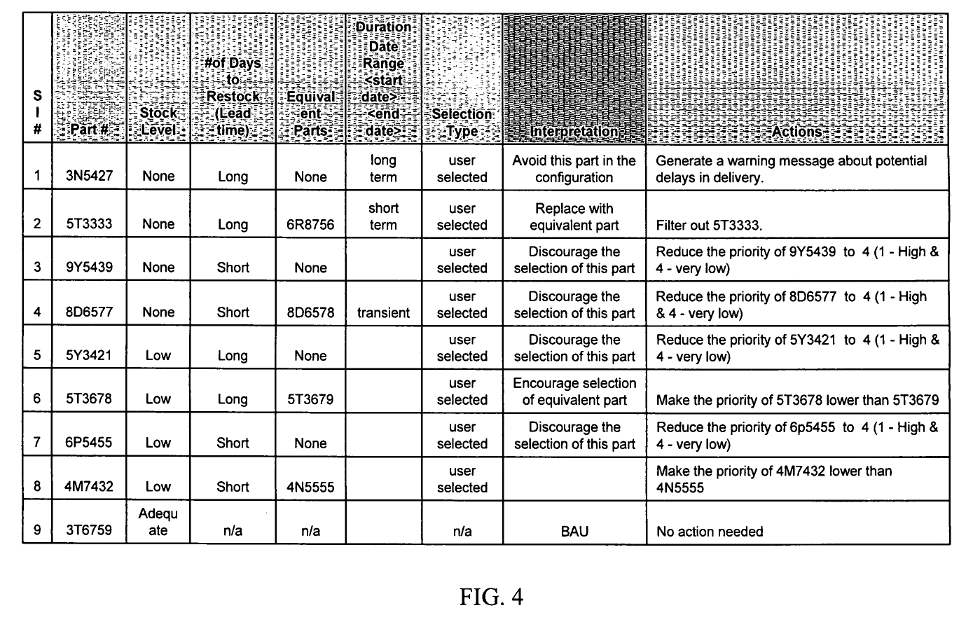

FIG. 4 is a chart illustrating an if-then rule comprising an supply data interpretation rule 116, in accordance with one embodiment of the present invention. Each row of the chart of FIG. 4 is a single rule. The chart of FIG. 4 shows that various data pertaining to a part can be stated in the if-portion of an supply data interpretation rule. The if-portion of a rule comprises all elements in the row for the rule, not including the element of the last column of the row. The chart of FIG. 4 also shows that the then-portion of an supply data interpretation rule may include an action text explaining the goal of the action in the then-portion of the rule. The then-portion of a rule comprises the element of the last column of the row for the rule.

Once the configuration rules 112 have been modified by rules modifying process 210 based on the supply data 114 and execution of the supply data interpretation rules 116, the configuration rules 112 are ready for execution. Consequently, configuration rules 112 are executed by configuration engine 202, which beings the process of interacting with the customer 102 via the user interface 204. Parts are presented (or not presented) to the customer 102 via the user interface 204 according to their priority levels set by the configuration rules 112. When the ordering process is complete, the configuration engine 202 outputs a selected configuration 206, which is then transferred to the order fulfillment manager 208, which initiates the manufacturing, testing and shipping of the selected configuration 206.

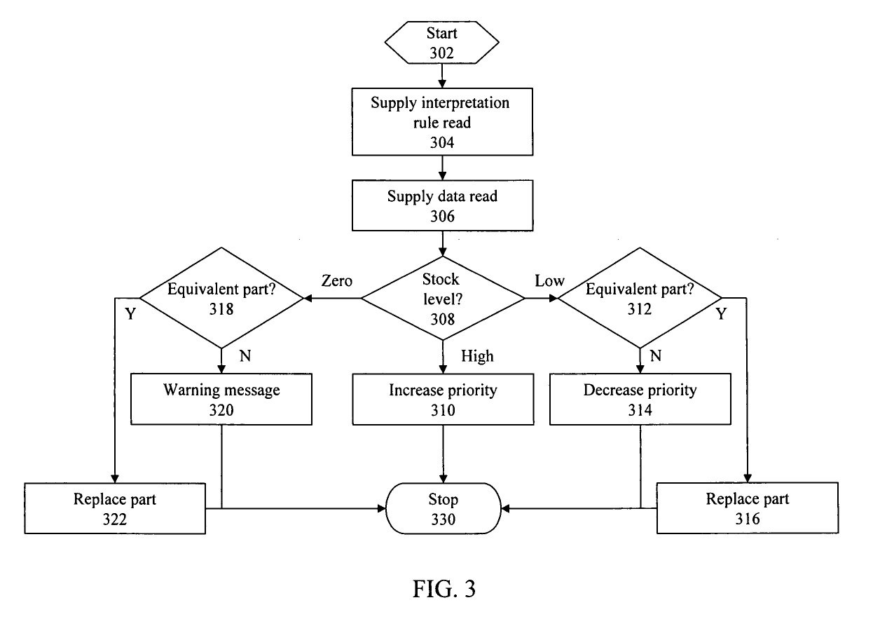

FIG. 3 is a flow chart depicting a process for executing a sample supply data interpretation rule, according to one embodiment of the present invention. The flow chart of FIG. 3 depicts the steps that occur when a sample supply data interpretation rule is executed by the rule modifying process 210, resulting in the modification of a configuration rule. The control flow of FIG. 3 begins with step 302 and moves directly to step 304.

In step 304, a sample supply data interpretation rule (from rule set 116) is read for execution. The sample supply data interpretation rule of FIG. 3 includes a rule by which: a) if the stock level of a first part is low and there is an equivalent part available, then the first part is replaced with the equivalent part, b) if the stock level of the first part is low and there is no equivalent part available, then the priority of the first part is decreased, c) if the stock level of the first part is zero and there is an equivalent part available, then the first part is replaced with the equivalent part, d) if the stock level of the first part is zero and there is no equivalent part available, then a warning is displayed for the customer 102 ordering the part and e) if the stock level of the first part is high, then the priority of the first part is increased.

In step 306, supply data (garnered from supply data 114) for the first part identified in the if-portion of the rule is read and the pertinent supply data values are inserted into their proper place in the supply data interpretation rule. Note that certain values, such as designators for in-stock values for a part, may be garnered from metadata interpretation chart 126, as explained in greater detail above. Steps 308-322 constitute the execution of the sample supply data interpretation rule.

In step 308, the stock level of the first part is evaluated. If the stock level of the first part is zero, then control flows to step 318; if the stock level is high, then control flows to step 310 and if the stock level is low, then control flows to step 312. In step 310, the priority level of the first part is increased, thereby modifying the configuration rules 112 to encourage presentation of the first part so as to increase sales of the first part.

In step 318, it is determined whether there is an equivalent part in stock that may replace the first part. If so, then the first part is replaced with the equivalent part in step 322, thereby modifying the configuration rules 112 to make the replacement so as to increase sales of the abundant equivalent part as opposed to the out-of-stock first part. If there is no equivalent part to replace the first part, then in step 320 the configuration rules 112 are modified so as to present a warning message to the customer 102 via the user interface 204 when the customer orders the first part, so as decrease or eliminate the possibility that the customer 102 will order the out-of-stock part.

In step 312, it is determined whether there is an equivalent part in stock that may replace the first part. If so, then the first part is replaced with the equivalent part in step 316, thereby modifying the configuration rules 112 to make the replacement so as to increase sales of the abundant equivalent part as opposed to the low stock first part. If there is no equivalent part to replace the first part, then in step 314 the priority level of the first part is decreased, thereby modifying the configuration rules 112 to discourage presentation of the first part so as to decrease sales of the first part. In step 330, the control flow of FIG. 3 ceases.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

1. A method for facilitating configuration selection when ordering computer equipment via a computer system, the method on the computer system comprising:
reading a plurality of configuration rules that define constituent parts that are presented to a user for selection when ordering the end product;
reading supply data for the constituent parts;
modifying the plurality of configuration rules in accordance with the supply data;
receiving a request from the user to order the end product; and
providing the user with information regarding constituent parts that comprise the end product, according to the plurality of configuration rules.

2. The method of claim 1, wherein the first step of reading further comprises:
reading a plurality of configuration rules that define constituent parts that are presented to a user for selection when ordering the end product, wherein a rule defines constituent parts that are at least one of compatible and required.

3. The method of claim 2, wherein the second step of reading further comprises:
reading supply data for the constituent parts, wherein supply data includes at least one of availability data for each constituent part, in-stock data for each constituent part, lead time data for each constituent part and quality data for each constituent part.

4. The method of claim 3, wherein the step of modifying comprises any one of:
restricting presentation of at least one constituent part to the user for selection when ordering the end product, if supply data indicates that supply levels of the at least one constituent part are low, wherein restricting presentation comprises displaying the at least one constituent part so as to discourage the user to select the at least one constituent part.

5. The method of claim 4, wherein the step of modifying comprises:
increasing presentation of at least one constituent part to the user for selection when ordering the end product, if supply data indicates that supply levels of the at least one constituent part are high, wherein increasing presentation comprises displaying the at least one constituent part so as to encourage the user to select the at least one constituent part.

6. The method of claim 1, further comprising:
reading a metadata interpretation chart that defines supply levels for constituent parts that are presented to a user for selection when ordering the end product.

7. The method of claim 6, further comprising:
associating supply levels with the supply data according to the metadata interpretation chart.

8. A computer program product comprising a computer usable medium embodying computer usable program code for facilitating configuration selection when ordering computer equipment comprising:
computer usable program code for reading a plurality of configuration rules that define constituent parts that are presented to a user for selection when ordering the end product;
computer usable program code for reading supply data for the constituent parts;
computer usable program code for modifying the plurality of configuration rules in accordance with the supply data;
computer usable program code for receiving a request from the user to order the end product; and
computer usable program code for providing the user with information regarding constituent parts that comprise the end product, according to the plurality of configuration rules.

9. The computer program product of claim 8, wherein the first computer usable program code for reading further comprises:
computer usable program code for reading a plurality of configuration rules that define constituent parts that are presented to a user for selection when ordering the end product, wherein a rule defines constituent parts that are at least one of compatible and required.

10. The computer program product of claim 9, wherein the second computer usable program code for reading further comprises:
computer usable program code for reading supply data for the constituent parts, wherein supply data includes at least one of availability data for each constituent part, in-stock data for each constituent part, lead time data for each constituent part and quality data for each constituent part.

11. The computer program product of claim 10, wherein the computer usable program code for modifying comprises:
computer usable program code for restricting presentation of at least one constituent part to the user for selection when ordering the end product, if supply data indicates that supply levels of the at least one constituent part are low, wherein restricting presentation comprises displaying the at least one constituent part so as to discourage the user to select the at least one constituent part.

12. The computer program product of claim 10, wherein the computer usable program code for modifying comprises:
computer usable program code for increasing presentation of at least one constituent part to the user for selection when ordering the end product, if supply data indicates that supply levels of the at least one constituent part are high, wherein increasing presentation comprises displaying the at least one constituent part so as to encourage the user to select the at least one constituent part.

13. The computer program product of claim 8, further comprising:
computer usable program code for reading a metadata interpretation chart that defines supply levels for constituent parts that are presented to a user for selection when ordering the end product.

14. The computer program product of claim 13, further comprising:
computer usable program code for associating supply levels with the supply data according to the metadata interpretation chart.

15. A computer system for facilitating configuration selection when ordering computer equipment, comprising:
a data repository for storing a plurality of configuration rules that define constituent parts that are presented to a user for selection when ordering the end product and for storing supply data for the constituent parts;
a processor configured for:
reading the plurality of configuration rules and the supply data; and
modifying the plurality of configuration rules in accordance with the supply data; and
an interface for receiving a request from the user to order the end product and providing the user with information regarding constituent parts that comprise the end product, according to the plurality of configuration rules.

16. The computer system of claim 15, wherein a rule defines constituent parts that are at least one of compatible and required.

17. The computer system of claim 16, wherein supply data includes at least one of availability data for each constituent part, in-stock data for each constituent part, lead time data for each constituent part and quality data for each constituent part.

18. The computer system of claim 17, wherein the step of modifying comprises at least one of:
restricting presentation of at least one constituent part to the user for selection when ordering the end product, if supply data indicates that supply levels of the at least one constituent part are low, wherein restricting presentation comprises displaying the at least one constituent part so as to discourage the user to select the at least one constituent part; and
increasing presentation of at least one constituent part to the user for selection when ordering the end product, if supply data indicates that supply levels of the at least one constituent part are high, wherein increasing presentation comprises displaying the at least one constituent part so as to encourage the user to select the at least one constituent part.

19. The computer system of claim 15, wherein the processor is further configured for:
reading a metadata interpretation chart that defines supply levels for constituent parts that are presented to a user for selection when ordering the end product.

20. The computer system of claim 19, wherein the processor is further configured for:
associating supply levels with the supply data according to the metadata interpretation chart.
